(19) United States
(12) Patent Application Publication
(10) Pub. No.: US 2015/0167173 A1
(43) Pub. Date: Jun. 18, 2015

(54) PRINTING METHOD FOR PRINTING AND PLATING PROCESS

(71) Applicants: Sang-Il Lee, Gunpo-si (KR); Jung-Sic Park, Seoul (KR); Ephraim Ulmer, Haifa (IL); Wen-Wei Guo, Wuxi City (CN); Yan Zhao, Wuxi City (CN); Dong Woo Lee, Seoul (KR)

(72) Inventors: Sang-Il Lee, Gunpo-si (KR); Jung-Sic Park, Seoul (KR); Ephraim Ulmer, Haifa (IL); Wen-Wei Guo, Wuxi City (CN); Yan Zhao, Wuxi City (CN); Dong Woo Lee, Seoul (KR)

(73) Assignee: GALTRONICS CORPORATION LTD., Tiberias (IL)

(21) Appl. No.: 14/389,549

(22) PCT Filed: Apr. 1, 2012
(86) PCT No.: PCT/IL12/00140

§ 371 Date: Feb. 25, 2015

(51) Int. Cl. C23C 18/16; H01Q 9/04; C23C 18/31

(52) U.S. Cl. CPC C23C 18/161; C23C 18/31; H01Q 9/0471

(57) ABSTRACT

A method for printing on a substrate, including providing a substrate having at least one three-dimensional surface and performing inkjet printing of an ink on at least a portion of the at least one three-dimensional surface by repositioning an inkjet printing head relative to the substrate in only two dimensions.

### FIELD OF THE INVENTION

The present invention relates to a method for the printing of an ink on a substrate, particularly useful in a printing and plating process.

### BACKGROUND OF THE INVENTION

The following documents are believed to represent the current state of the art:

U.S. Pat. Nos. 3,900,320; 5,342,501; 5,547,559; 5,955,179; 7,179,741; 7,510,985 and 7,608,203.

Published PCT applications: WO 2005/45095; WO 2005/56875; WO 2006/123144; WO 2008/12512 and WO 2008/40936.

Korean Patent Nos. 10-0839557 and 10-0830970.

### SUMMARY OF THE INVENTION

The present invention seeks to provide an improved printing method for the inkjet printing of an ink on a substrate, which method is particularly useful in the manufacture of plated antennas.

There is thus provided in accordance with a preferred embodiment of the present invention a method for printing on a substrate, including providing a substrate having at least one three-dimensional surface and performing inkjet printing of an ink on at least a portion of the at least one three-dimensional surface by repositioning an inkjet printing head relative to the substrate in only two dimensions.

In accordance with a preferred embodiment of the present invention, the method also includes plating at least one conductive layer on the printed portion of the at least one three-dimensional surface of the substrate.

Preferably, the conductive layer includes a metal layer.

Preferably, the metal layer includes an antenna.

In accordance with another preferred embodiment of the present invention, the at least one three-dimensional surface of the substrate includes a through-hole and the printed portion is formed on an inner surface of the through-hole.

Preferably, the plating includes electroplating.

Alternatively, the plating includes electroless plating.

Preferably, the substrate includes a non-conductive substrate.

Preferably, the non-conductive substrate includes plastic.

Preferably, the ink includes a non-conductive ink.

Preferably, the inkjet printing includes piezoelectric inkjet printing.

There is further provided in accordance with another preferred embodiment of the present invention an antenna, including a substrate having at least one three-dimensional surface, a pattern of ink printed on at least a portion of the three-dimensional surface by repositioning an inkjet printing head relative to the substrate in only two dimensions and at least one conductive layer plated on at least a portion of the pattern of ink.

There is additionally provided in accordance with yet another preferred embodiment of the present invention a method for printing on a bore of a through-hole, including providing a substrate having at least one through-hole formed therein having a bore and performing inkjet printing of an ink on at least a portion of the bore of the through-hole by repositioning an inkjet printing head relative to the substrate in only two dimensions.

Preferably, the method also includes plating at least one conductive layer on the printed portion of the bore.

### BRIEF DESCRIPTION OF THE DRAWINGS

The present invention will be understood and appreciated more fully from the following detailed description, taken in conjunction with the drawings in which:

FIG. 1 is a simplified flow diagram illustrating a printing and plating process, in accordance with a preferred embodiment of the present invention;

FIG. 2 is a simplified pictorial illustration of a printing method useful in a process of the type shown in FIG. 1, in accordance with a preferred embodiment of the present invention;

FIGS. 3A-3C are respective simplified expanded illustrations of successive stages of a printing method of the type shown in FIG. 2; and

FIGS. 4A-4F are respective simplified expanded perspective view illustrations of further successive stages of a printing method of the type shown in FIGS. 2-3C.

### DETAILED DESCRIPTION OF THE INVENTION

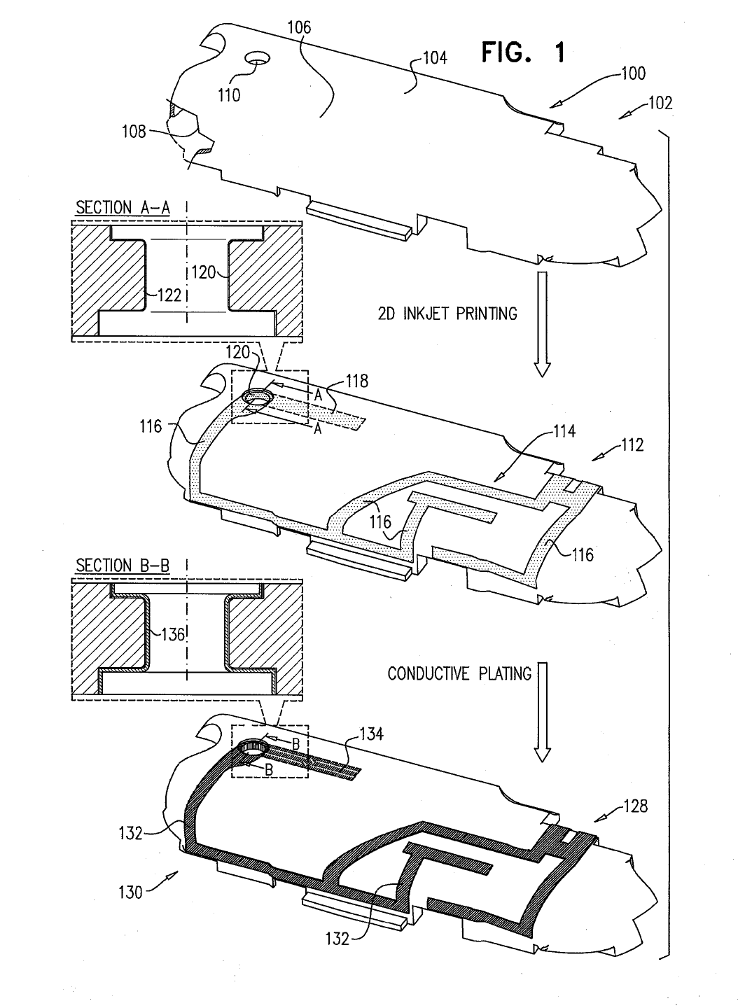

Reference is now made to FIG. 1, which is a simplified flow diagram illustrating a printing and plating process 100, in accordance with a preferred embodiment of the present invention.

As seen in FIG. 1, process 100 preferably begins at a first step 102, with the provision of a substrate 104. Substrate 104 preferably has at least one three-dimensional (3D) surface, here preferably including a curved upper surface 106 and a curved lower surface 108. Upper and lower surfaces 106 and 108 are preferably connected by way of a through-hole 110 formed therebetween. It is appreciated, however, that the illustrated configuration of substrate 104 is exemplary only and that the 3D topography of surfaces 106 and 108 and other surface features of substrate 104 may be adapted according to the design requirements of a device into which substrate 104 is to be incorporated. Substrate 104 is preferably a non-conductive substrate and is particularly preferably formed of plastic.

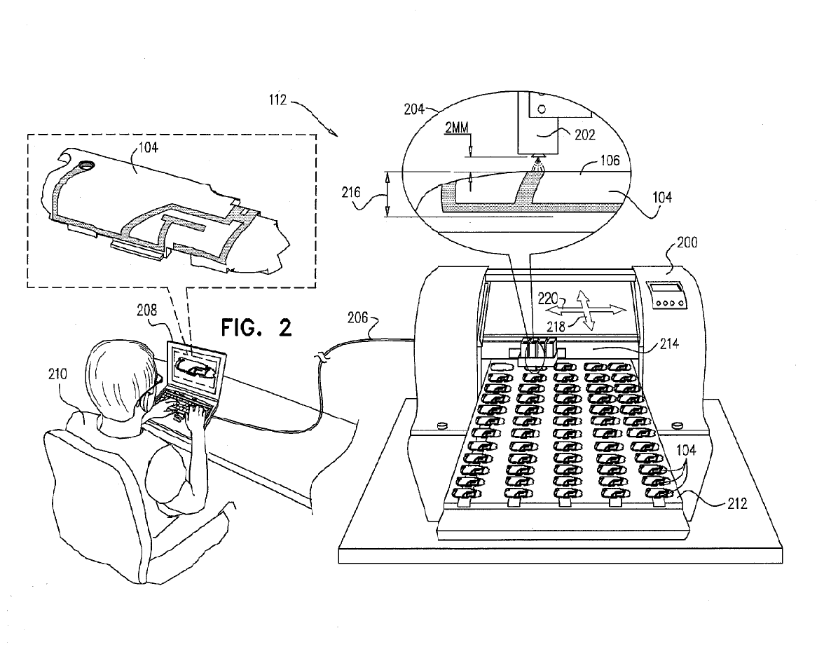

Process 100 further includes a second inkjet printing step 112. At printing step 112 a pattern of ink 114 is printed on at least a portion of at least one 3D surface of substrate 104 by repositioning an inkjet printing head relative to substrate 104 in only two dimensions. Printing step 112 may hence be termed a two-dimensional (2D) inkjet printing step. It is appreciated that printing step 112 is a non-contact printing step, at which printing step 112 droplets of ink are individually ejected from an inkjet printing head as it is repositioned in two dimensions offset from and with respect to substrate 104. It is further appreciated that the repositioning of the inkjet printing head with respect to substrate 104 in two dimensions may involve the repositioning of the printing head and/or the substrate 104, as will be explained in greater detail below with reference to FIGS. 2-4F.

It is a particular feature of a preferred embodiment of the present invention that a 2D non-contact printing method is used to print a pattern, such as pattern of ink 114, on a 3D surface, such as surfaces 106 and 108 of substrate 104. The 2D printing method of the present invention is advantageous in comparison to pad printing, laser direct structuring (LDS) and the printing of inks containing metallic particles, all of which techniques are conventionally used for the forming of a pattern on a 3D surface. In particular, the 2D printing method of the present invention is quicker, simpler and more reliable than pad printing methods and less expensive than LDS, which requires specially engineered substrate materials. Furthermore, the 2D printing method of the present invention is simpler to carry out than printing methods involving inks containing metallic particles, due the difficulty involved in keeping such metallic inks homogenous during the printing process.

Further details pertaining to 2D inkjet printing step 112, including details of the mechanism by which 2D inkjet printing may be used to achieve the printing of a pattern on a 3D surface of a substrate, will be provided henceforth with reference to FIGS. 2-4F.

The printed portion of at least one 3D surface of substrate 104 here preferably includes, by way of example, a printed portion 116 located on 3D upper surface 106 of substrate 104, a printed portion 118 located on 3D lower surface 108 of substrate 104 and a printed portion 120 located on a bore 122 of through-hole 110 penetrating substrate 104, as best seen in section A-A. It is appreciated that the shape of through-hole 110 illustrated in section A-A is shown by way of example only and that through-holes of various alternative shapes, such as single and double conic through-holes, may also be printed by way of 2D inkjet printing step 112.

The printing of portions 116 and 118, respectively located on upper and lower surfaces 106 and 108 of substrate 104, is preferably achieved by means of carrying out printing step 112 twice, with substrate 104 disposed so as to sequentially expose respective upper and lower surfaces 106 and 108 to an inkjet printing head, as will be described in greater detail below with reference to FIG. 2. The printing of portion 120 may be achieved by way of overflow of ink into the bore of through-hole 110 due to gravity, by way of suctioning of ink through the bore of the through-hole 110 or by way of any other suitable mechanisms known in the art.

Ink pattern 114 is preferably formed of a non-conductive ink suitable for printing on plastic substrate 104 and onto at least a portion of which ink pattern 114 a conductive layer may be plated, thus allowing conductive plating of at least a portion of substrate 104, as will be described below. Examples of non-conductive inks suitable for use in 2D inkjet printing step 112 include inks of the types described in Korean Patent Nos. 10-0839557 and 10-0830970, assigned to Galtronics Korea Co., Ltd., a wholly owned subsidiary of the assignee of the present application, the descriptions of which are hereby incorporated by reference.

Following second 2D inkjet printing step 112, process 100 continues to a third conductive plating step 128. At conductive plating step 128, at least one conductive layer 130 is plated on top of at least a portion of printed ink pattern 114. Conductive layer 130 here preferably includes a metal layer 132 plated onto printed portion 116, a metal layer 134 plated onto printed portion 118 and a metal layer 136 plated onto printed portion 120, as best seen in section B-B. Preferably, the conductive pattern thus formed functions as an antenna.

As seen most clearly at step 128, the metal layer 136 formed on the printed portion 120 of the bore 122 of through-hole 110 preferably provides a conductive connection between metal layer 132 lying on upper surface 106 and metal layer 134 lying on lower surface 108 of substrate 104. Through-hole 110 thus acts as a conductive conduit connecting the conductive portions of upper and lower surfaces 106 and 108 of substrate 104.

Suitable metal plating methods that may be implemented at plating step 128 are well known in the art and include electroplating and electroless plating methods. The use of electroless plating at plating step 128 has been found to be advantageous in comparison to electroplating, since in electroless plating the need for electrodes is obviated, thereby conserving valuable space on substrate 104. Furthermore, electroless plating provides improved uniformity of thickness of the plated metal layer, in comparison to electroplating.

It is appreciated that respective first, second and third steps 102, 112 and 128, although preferably performed sequentially in the order outlined above, may be separated by the performance or repetition of other steps, which other steps may or may not have been described above. For example, a drying step may separate 2D inkjet printing step 112 from plating step 128. Similarly, 2D inkjet printing step 112 may be sequentially performed on other surfaces of substrate 104, in addition to surfaces 106 and 108, prior to the commencement of plating step 128. Other preparatory steps known in the art, including, by way of example, washing, cleaning and degreasing steps, may also be inserted in process 100.

It is further appreciated that although process 100 has been described above with reference to the formation of antenna 130 on substrate 104, process 100 may alternatively be used for the formation of any conductive structure on a 3D surface of a printable substrate. Such structures may have a wide range of uses, including, for example, as interconnect in electrical systems.

Reference is now made to FIG. 2, which is a simplified pictorial illustration of a printing method useful in a process of the type shown in FIG. 1, in accordance with a preferred embodiment of the present invention. It is appreciated that the printing method shown in FIG. 2 is a particularly preferred embodiment of 2D inkjet printing step 112 of printing and plating process 100 shown in FIG. 1.

As seen in FIG. 2, there is provided a printer 200. Printer 200 is preferably an inkjet printer, used to carry out non-contact inkjet printing. Particularly preferably, printer 200 is a 3PL ultra-micro dot printer with an Epson MicroPiezo printing head 202, which printing head 202 is seen most clearly at enlargement 204. It is appreciated that although, for the sake of simplicity, only a single printing head 202 is shown in FIG. 2, the inclusion of a greater number of printing heads in printer 200 is also possible. Printer 200 is preferably capable of printing at a maximum resolution of 5760*1440 dpi with a droplet size of 1.5 pL.

Printer 200 is preferably connected by way of a cable 206 to a computer 208, which computer 208 is preferably operated by an operator 210. It is appreciated, however, that the computer function of computer 208 may alternatively be integrated into printer 200, whereby computer 208 may be obviated. It is further appreciated that 2D inkjet printing step 112, due to its advantageous simplicity, may readily be automated to such an extent that the presence of operator 210 is wholly or partially unnecessary.

Printer 200 is preferably fed by a flat bed printing jig 212 on which flat bed 212 multiple ones of substrate 104 are preferably arrayed. Multiples ones of substrate 104 are preferably held in cavities machined into the surface of flat bed 212. The presence of these cavities facilitates accurate positioning of multiple ones of substrate 104 in relation to the printing head 202 of printer 200. It is appreciated that the illustrated embodiment, showing an array comprising five columns and twelve rows of substrate 104, is shown by way of example only. In one preferred embodiment of the present invention, flat bed 212 is machined so as to carry a matrix comprising six columns and nineteen rows of substrate 104. It is further appreciated that the size and carrying capacity of flat bed 212 may be altered in accordance with the production requirements of 2D inkjet printing step 112.

Printer 200 includes a height sensor (not shown) housed in region 214 of printer 200. The height sensor automatically detects the position of the highest point of a surface located beneath printing head 202. The position of printing head 202 is then automatically adjusted so as to preferably lie 2 mm above the highest point of the surface, as best seen at enlargement 204 in relation to upper surface 106. The 2 mm separation of printing head 202 from the highest point of surface 106 corresponds to the optimum separation of printing head from print target in order to achieve maximum inkjet printing resolution.

It is readily appreciated that due to the non-planar profile of surface 106, portions of surface 106 will lie at distances greater than 2 mm from printing head 202 when printing head 202 is positioned at its optimum 2 mm separation from the highest point of surface 106. However, experimentation has shown that a focusable range 216 may be defined, which focusable range 216 lies beyond the optimum 2 mm distance from printing head 202 and yet within which focusable range 216 printing head 202 nonetheless prints 3D surface 106 of substrate 104 with an acceptable resolution. The maximum focusable range 216 for the inkjet printer described above has been found to be approximately 7 mm. It is appreciated, however, that focusable ranges of different sizes may be defined, depending on both the required resolution of ink pattern 114 and the structure of the printing head 202.

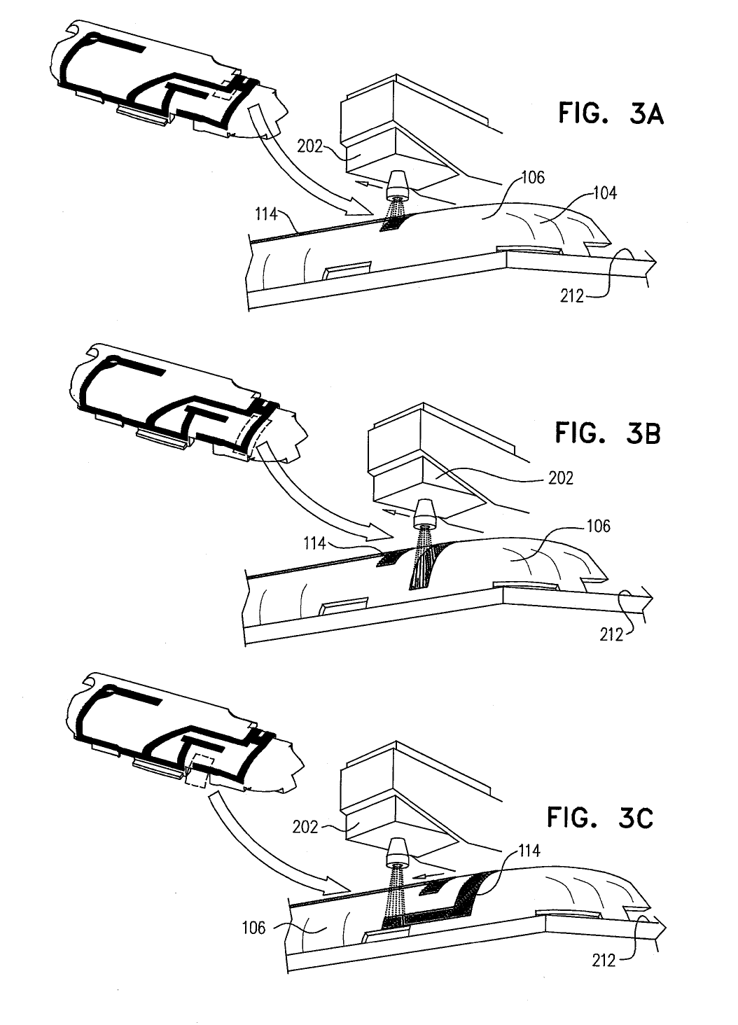

Hence, provided that the variation in height of a 3D surface of substrate 104 does not exceed the extent of the focusable range 216, ink pattern 114 may be printed on the 3D surface, using printer 200 in its unmodified 2D operational form. FIGS. 3A-3C respectively show printing head 202 printing selected portions of ink pattern 114 on respective regions of 3D surface 106 of substrate 104. As apparent from consideration of FIGS. 3A-3C, the height of printing head 202 is preferably fixed and the separation between printing head 202 and 3D surface 106 therefore varies as printing head 202 is relocated with respect to substrate 104. However, printing head 202 nonetheless prints ink pattern 114 with an acceptable, albeit non-constant, resolution since the printed portions of surface 106 lie within the above-described focusable range 216. 3D substrate 104 may thus be printed in a simple, highly efficient and readily automated manner.

In cases where the variation in height of a 3D surface of substrate 104 to be printed exceeds the extent of the focusable range 216, angled cavities may be machined into flat bed 212. By placing ones of substrate 104 in these angled cavities, the substrates may be appropriately angled so as to ensure that those portions of the 3D surfaces to be printed are located within the focusable range 216 of printer 200.

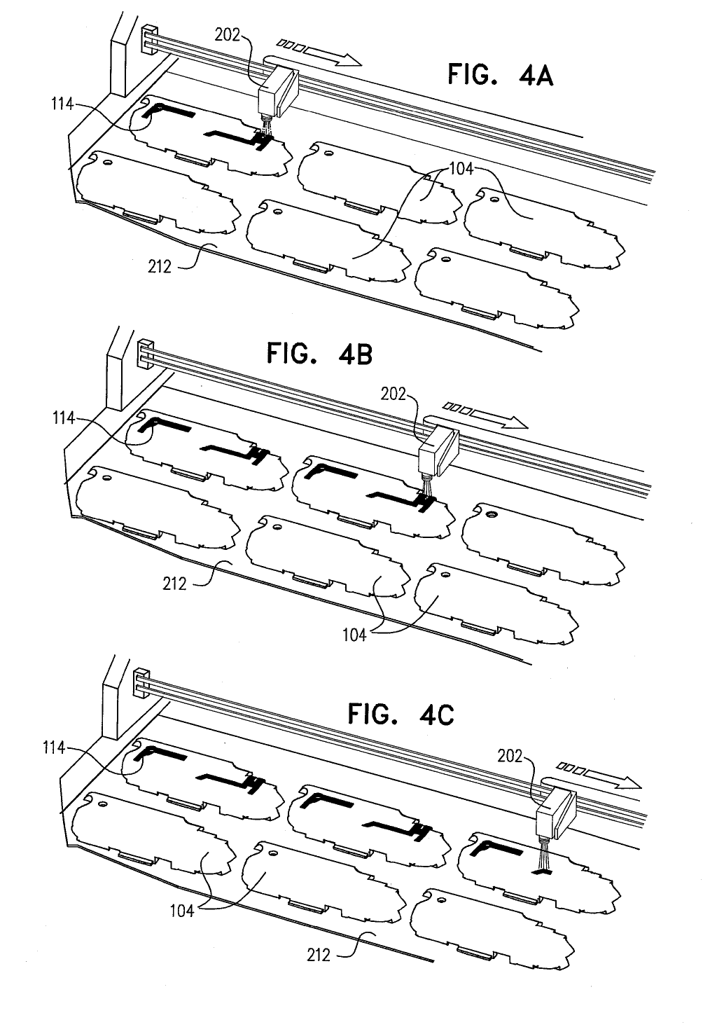

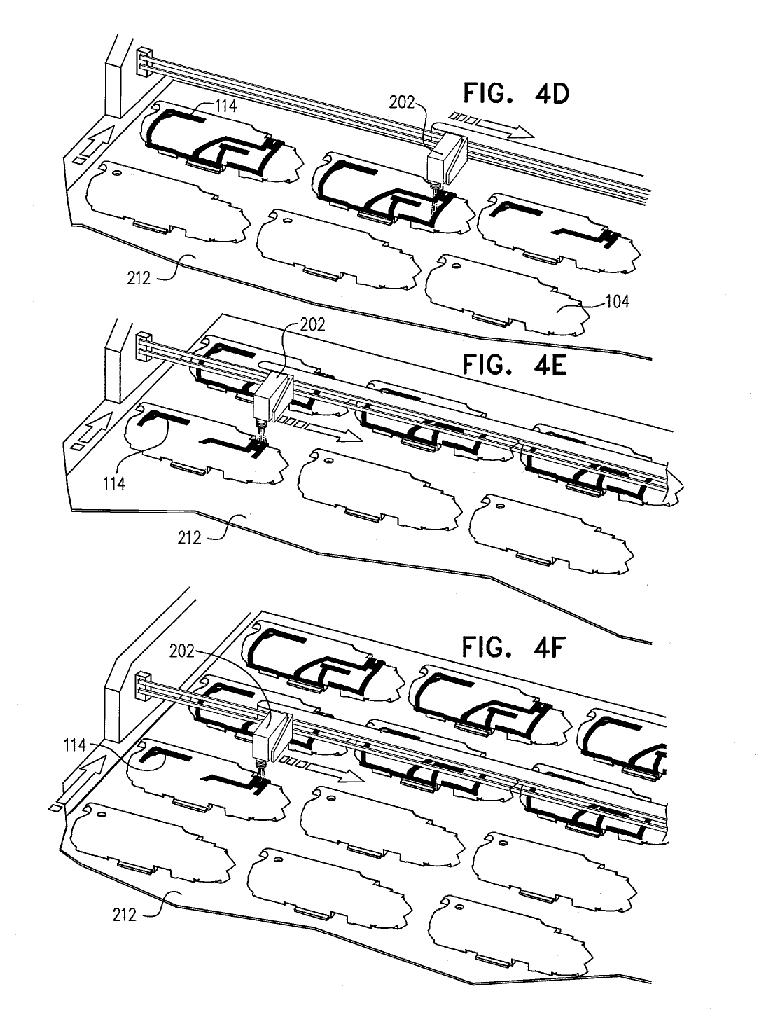

In operation of printer 200, flat bed 212 preferably incrementally travels through printer 200 in a planar fashion, in a direction along a longitudinal axis 218. Preferably concurrently, printing head 202 preferably incrementally travels in a planar fashion, in a direction along a transverse axis 220, whilst spraying a predetermined pattern of ink droplets onto the array of substrates 104, preferably in accordance with the well-known mechanism of piezoelectric inkjet printing. FIGS. 4A-4F respectively illustrate selected successive stages in the progressive 2D repositioning of printing head 202 with respect to flat bed 212. As appreciated from consideration of FIGS. 4A-4F, printing head 202 is preferably repositioned in only two dimensions with respect to flat bed 212 by way of the repositioning of both printing head 202 and flat bed 212.

Following the printing of a first surface of multiple ones of substrate 104, such as surface 106 as shown in FIG. 2, flat bed 212 may be transferred from printer 200 to another printer, inverted, and an additional surface of multiple ones of substrate 104, such as surface 108, subsequently printed. A minimal delay between such sequential printings may be required in order to allow drying of ink pattern 114. It is appreciated that due to the carrying capacity of flat bed 212, multiple ones of substrate 104 may be effectively simultaneously printed.

It will be appreciated by persons skilled in the art that the present invention is not limited to what has been particularly shown and described hereinabove. Rather the scope of the present invention includes both combinations and subcombinations of various features described hereinabove as well as modifications thereof which would occur to a person of skill in the art upon reading the foregoing description and which are not in the prior art.

1. A method for printing on a substrate, comprising:
providing a substrate having at least one three-dimensional surface; and
performing inkjet printing of an ink on at least a portion of said at least one three-dimensional surface of said substrate by repositioning an inkjet printing head relative to said substrate in only two dimensions.

2. A method for printing on a substrate according to claim 1, and also comprising plating at least one conductive layer on the printed portion of said at least one three-dimensional surface of said substrate.

3. A method for printing on a substrate according to claim 2, wherein said conductive layer comprises a metal layer.

4. A method for printing on a substrate according to claim 3, wherein said metal layer comprises an antenna.

5. A method for printing on a substrate according to claim 2, wherein said at least one three-dimensional surface of said substrate includes a through-hole and said printed portion is formed on a bore of said through-hole.

6. A method for printing on a substrate according to claim 2, wherein said plating comprises electroplating.

7. A method for printing on a substrate according to claim 2, wherein said plating comprises electroless plating.

8. A method for printing on a substrate according to claim 1, wherein said substrate comprises a non-conductive substrate.

9. A method for printing on a substrate according to claim 8, wherein said non-conductive substrate comprises plastic.

10. A method for printing on a substrate according to claim 1, wherein said ink comprises a non-conductive ink.

11. A method for printing on a substrate according to claim 1, wherein said inkjet printing comprises piezoelectric inkjet printing.

12. An antenna, comprising:
a substrate having at least one three-dimensional surface;
a pattern of ink printed on at least a portion of said three-dimensional surface by repositioning an inkjet printing head relative to said substrate in only two dimensions; and
at least one conductive layer plated on at least a portion of said pattern of ink.

13. A method for printing on a bore of a through-hole, comprising:
providing a substrate having at least one through-hole formed therein having a bore; and
performing inkjet printing of an ink on at least a portion of said bore of said through-hole by repositioning an inkjet printing head relative to said substrate in only two dimensions.

14. A method for printing on a bore of a through-hole according to claim 13, and also comprising plating at least one conductive layer on the printed portion of said bore.
